(19) United States
(12) Patent Application Publication
(10) Pub. No.: US 2005/0021976 A1
(43) Pub. Date: Jan. 27, 2005

(54) Systems and methods for controlling access to an event

(75) Inventor: Dirk Trossen, Cambridge, MA (US)

Correspondence Address: ALSTON & BIRD LLP;BANK OF AMERICA PLAZA, 101 SOUTH TRYON STREET, SUITE 4000, CHARLOTTE, NC, 28280-4000, US

(73) Assignee: Nokia Corporation, Espoo (FI)

(21) Appl. No.: 10/602,078

(22) Filed: Jun. 23, 2003

(51) Int. Cl. H04K 1/00

(52) U.S. Cl. 713/182

(57) ABSTRACT

A system, method and mobile station are provided for controlling access to an event, where the event is associated with event-based information available within a network. The system includes a first network entity, a second network entity and an event server. The first network entity can control access to the event-based information associated with the event. The first network entity is capable of receiving consent to access the event-based information, and thereafter automatically creating an authorization. After creating the authorization, the first network entity can transmit the authorization, which the second network entity can then receive. Then, the second network entity can transmit a subscription message, where the subscription message includes the authorization and an event package describing the event-based information. The event server, which is capable of maintaining the event, can receive the subscription message, and then determine whether to accept the subscription message based upon the authorization.

### FIELD OF THE INVENTION

The present invention relates generally to telecommunications networks and, more particularly, relates to systems and methods for controlling access to an event associated with event-based information available within a network.

### BACKGROUND OF THE INVENTION

Access control has been a topic for research, standardization, and product development for several years, as it marks one of the fundamental tasks for information processing. In this regard, access control typically constitutes the rights of each involved party to access and use certain resources and information, such as files or events. For the latter, the Session Initiation Protocol (SIP) event framework is supposed to become a key element within the SIP infrastructure to enable event-based information provisioning to any node in the Internet. Examples for this kind of information are presence, location information, or content/service availability. However, the current efforts in this SIP event framework lack any kind of access control that would be generic for SIP events in general.

For now, the current efforts in SIP leave access control functionality entirely to the particular event package to implement. The only functionality currently discussed in the Internet Engineering Task Force (IETF) is concerned with so-called watcher subscriptions, in which an entity is able to subscribe to the watcher list of a particular event as to be notified when a new watcher wishes to subscribe to a particular event. With this, on-line authorizations of subscriptions are supported. However, the current efforts do not address how a particular event server, dealing with event information of a particular user, obtains information about the access control rights for this event information to thereby ensure proper access right controlled subscriptions other than using online verification.

Further, the definition and handling of access rights has so far entirely been left to the particular event server that implements a particular event package. One solution that has been proposed includes access controlled SIP events based on access control lists that reside on a dedicated access control server. Such a technique is particularly important for scenarios such as “buddy” lists or other schemes in which the parties receiving access are known before the actual subscription happens. Whereas such a technique is adequate for various scenarios, such techniques typically cannot be extended for scenarios where the parties receiving access are not known prior to requesting access. As an example, consider a service provider offering web page based delivery of a service that requires access to a particular SIP event resource related to the user. In order to grant the service provider (which would subscribe to the SIP event eventually) access to the SIP event resource, the user must typically setup the access rights specifically at an access control server for the service provider prior to the service provider requesting the SIP event resource.

Alternatively, the user must utilize techniques such as online verification or watcherinfo. Such a verification technique includes contacting the user upon receiving the provider's subscription to thereby request the user's consent to providing access to the SIP event resource. This type of technique, however, has drawbacks. In this regard, subscriptions for which access is not properly defined may occur quite frequently, thus resulting in increased wireless link bandwidth consumption, as well as increased response time in providing the requested service.

### SUMMARY OF THE INVENTION

In light of the foregoing background, embodiments of the present invention provide a system and method for controlling access to an event associated with event-based information available within a network, where a first network entity, such as a user device, controls access to the event-based information. Embodiments of the present invention provide an authorization method for access control to event-based information that reduces the overhead of consent messaging compared to conventional techniques. In addition, embodiments of the present invention allow the user of the first network entity to consent to a network entity receiving event-based information having access controlled by the user, without requiring the user to preprogram the network entity into an access control list.

According to one aspect of the present invention, a system is provided for controlling access to an event maintained by an event server, where the event is associated with event-based information available within a network. The system includes a first network entity, a second network entity and an event server. The first network entity is capable of controlling access to the event-based information associated with the event. In this regard, the first network entity is capable of receiving consent to access the event-based information, and thereafter automatically creating an authorization. The first network entity can also be capable of receiving at least one parameter in addition to the consent. In such an instance, the first network entity can create the authorization including the parameters.

Before receiving consent to access the event-based information, the second network entity, such as a requester, can transmit a request to the first network entity to access the event-based information. More particularly, the second network entity can transmit the request by transmitting a trigger to the first network entity such that the first network entity can execute the trigger to thereby activate the request to access the event-based information. After creating the authorization, the first network entity can transmit the authorization. The second network entity can then receive the authorization. Then, the second network entity can transmit a subscription message, where the subscription message includes the authorization and an event package describing the event-based information. The event server, which is capable of maintaining the event, can receive the subscription message.

After receiving the subscription message, the event server can then determine whether to accept the subscription message based upon the authorization. Also, the event server can store the authorization in a cache maintained by the event server. In this regard, the event server can store the authorization such that the event server can retrieve the authorization from the cache maintained in response to receiving one or more subsequent subscription messages, where the subsequent subscription messages include an event package and may or may not include the authorization.

The event server can determine whether to accept the subscription message in any of a number of different manners. For example, the event server may be capable of determining whether to accept the subscription message by first verifying the authorization. Then, the event server can accept the subscription message if the authorization is verified to thereby provide the second network entity with access to the event. In instances in which the parameters specify a granularity, the event server can then provide access to the event with the predefined granularity. The event server can verify the authorization in any of a number of different techniques. For example, the event server may be capable of verifying the authorization by verifying that a predefined frequency and/or time period has not been exceeded. Additionally or alternatively, for example, the event server may be capable of verifying the authorization by verifying a shared secret.

A mobile station and method of access control are also provided. Embodiments of the present invention therefore provide an improved system and method for access control of an event associated with event-based information. By creating and including an authorization to access the event-based information in a request for access to the event, embodiments of the present invention reduce the overhead of consent messaging compared to conventional techniques since a separate authorization need not be transmitted from the event server to the mobile station. In addition, because the authorization is transmitted from the first network entity, embodiments of the present invention allow the user of the first network entity to consent to a second network entity accessing the event associated with the event-based information without requiring the user to preprogram the second network entity's identity into an access control list. Therefore, the systems and methods of embodiments of the present invention solve the problems identified by prior techniques and provide additional advantages.

### BRIEF DESCRIPTION OF THE DRAWINGS

Having thus described the invention in general terms, reference will now be made to the accompanying drawings, which are not necessarily drawn to scale, and wherein:

FIG. 1 shows a system that supports controlling access to an event associated with event-based information available within a network, according to one embodiment of the present invention;

FIG. 2 is a schematic block diagram of a mobile station that may act as either a user device, an SIP event server, a resource or a requester according to embodiments of the present invention;

FIG. 3 shows a functional diagram of a server, that may also act as either a user device, an SIP event server, a resource or a requester, according to embodiments of the present invention; and

FIG. 4 shows message flows between entities in a method of controlling access to an event according to one embodiment of the present invention.

### DETAILED DESCRIPTION OF THE INVENTION

The present invention now will be described more fully hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout.

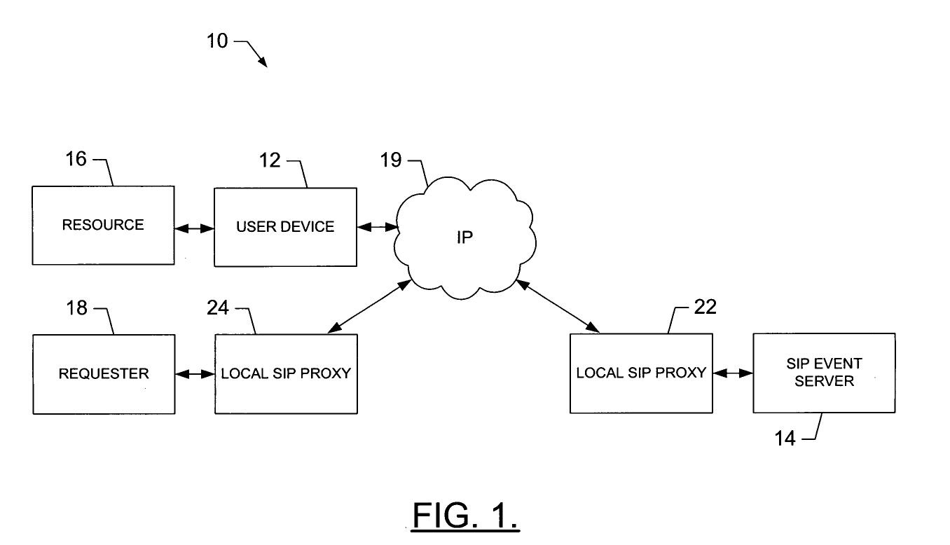

Referring now to FIG. 1, a general system 10 is shown that supports access control in networks. The system generally includes a user device 12 (i.e., first network entity) that includes, or otherwise controls access to, one or more resources 16 capable of providing at least a portion of requested event-based information. The system also generally includes an SIP event server 14, a requester 18 (i.e., a second network entity), and an IP communications network 19 through which the user device, the SIP event server and the requester communicate.

The user device 12 may comprise any of a number of elements, devices and/or systems capable of controlling access to event-based information available from the resources 16 to which a requester 18 requests access, where the event-based information is associated with an event. For example, a user device may comprise a processing element, such as a personal computer, laptop computer, server computer or other high level processor. Alternatively, a user device may comprise a mobile station or other user device capable of controlling access to event-based information available from one or more resources. In this regard, a resource can comprise any of a number of elements, devices and/or systems capable of providing event-based information. The event-based information can comprise any of a number of different types of information including, for example, presence, location information, content and/or service availability, or the like. For example, a resource can be capable of providing event-based information comprising the availability of services such as printing services, computing services, location determining services or the like. Also, for example, a resource can be capable of providing event-based information such as application information (e.g., software calendar information) and/or state information (e.g., current activity). As shown, the user devices may be in communication with the SIP event server 14 in any of a number of different manners, including directly and/or indirectly (e.g., via the IP communications network 19).

The requester 18 may be any entity, device, system or the like that requests access to events associated with the event-based information available from the resources 16 under the control of the user devices 12. The SIP event server 14 may comprise any entity, device, system or the like that is capable of controlling access to events, and storing event package subscriptions based upon such access control, where one or more of the event packages may relate to access-controlled event-based information of the resources. In this regard, the SIP event sever may be capable of receiving, from the requester, an authorization of the user to access an event associated with event-based information available from a resource, and thereafter grant the requester access to the event in accordance with the authorization.

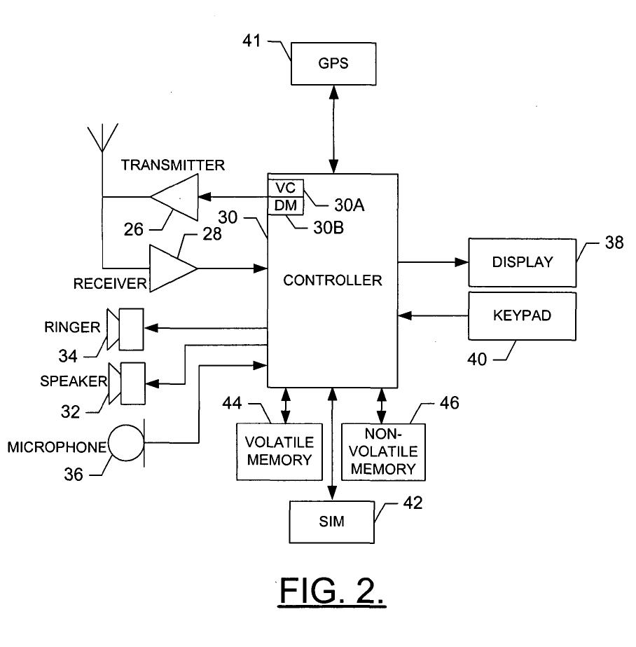

Referring now to FIG. 2, a functional diagram of a mobile station is shown that may act as either a user device 12, an SIP Event Server 14, a resource 16 or a requester 18 according to embodiments of the invention. Although shown as separate entities, in some embodiments, a single entity may support a logically separate, but co-located, user device 12 with a respective resource. It should also be understood that the mobile station illustrated and hereinafter described is merely illustrative of one type of mobile station that would benefit from the present invention and, therefore, should not be taken to limit the scope of the present invention. While several embodiments of the mobile station are illustrated and will be hereinafter described for purposes of example, other types of mobile stations, such as portable digital assistants (PDAs), pagers, laptop computers and other types of voice and text communications systems, can readily employ the present invention.

The mobile station includes a transmitter 26, a receiver 28, and a controller 30 that provides signals to and receives signals from the transmitter and receiver, respectively. These signals include signaling information in accordance with the air interface standard of the applicable cellular system, and also user speech and/or user generated data. In this regard, the mobile station can be capable of operating with one or more air interface standards, communication protocols, modulation types, and access types. More particularly, the mobile station can be capable of operating in accordance with any of a number of first-generation (1 G), second-generation (2 G), 2.5 G and/or third-generation (3 G) communication protocols or the like. For example, the mobile station may be capable of operating in accordance with 2 G wireless communication protocols IS-136 (TDMA), GSM, and IS-95 (CDMA). Some narrow-band AMPS (NAMPS), as well as TACS, mobile terminals may also benefit from the teaching of this invention, as should dual or higher mode phones (e.g., digital/analog or TDMA/CDMA/analog phones).

It is understood that the controller 30 includes the circuitry required for implementing the audio and logic functions of the mobile station. For example, the controller may be comprised of a digital signal processor device, a microprocessor device, and various analog to digital converters, digital to analog converters, and other support circuits. The control and signal processing functions of the mobile station are allocated between these devices according to their respective capabilities. The controller thus also includes the functionality to convolutionally encode and interleave message and data prior to modulation and transmission. The controller can additionally include an internal voice coder (VC) 30A, and may include an internal data modem (DM) 30B. Further, the controller may include the functionally to operate one or more software programs, which may be stored in memory. For example, the controller may be capable of operating a connectivity program, such as a conventional Web browser. The connectivity program may then allow the mobile station to transmit and receive Web content, such as according to the Wireless Application Protocol (WAP), for example.

The mobile station also comprises a user interface including a conventional earphone or speaker 32, a ringer 34, a microphone 36, a display 38, and a user input interface, all of which are coupled to the controller 30. The user input interface, which allows the mobile station to receive data, can comprise any of a number of devices allowing the mobile station to receive data, such as a keypad 40, a touch display (not shown) or other input device. In embodiments including a keypad, the keypad includes the conventional numeric (0-9) and related keys (#, *), and other keys used for operating the mobile station.

In addition, the mobile station can include a positioning sensor, such as a global positioning system (GPS) sensor 41. In this regard, the GPS sensor is capable of determining a location of the mobile station, such as longitudinal and latitudinal directions of the mobile station. The mobile station can also include memory, such as a subscriber identity module (SIM) 42, a removable user identity module (R-UIM) or the like, which typically stores information elements related to a mobile subscriber. In addition to the SIM, the mobile station can include other memory. In this regard, the mobile station can include volatile memory 44, such as volatile Random Access Memory (RAM) including a cache area for the temporary storage of data. The mobile station can also include other non-volatile memory 46, which can be embedded and/or may be removable. The non-volatile memory can additionally or alternatively comprise an EEPROM, flash memory or the like. The memories can store any of a number of pieces of information, and data, used by the mobile station to implement the functions of the mobile station. For example, the memories can store an identifier, such as an international mobile equipment identification (IMEI) code, capable of uniquely identifying the mobile station, such as to a mobile switching center (MSC). Also, for example, the memories can store instructions for creating authorizations for access to resources controlled by the user, as described below.

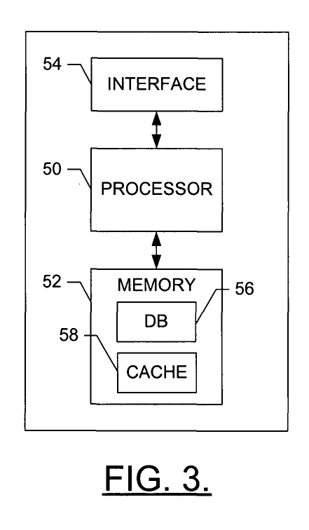

Reference is now drawing to FIG. 3, which illustrates another functional diagram of an entity that may act as either a user device 12, an SIP Event Server 14, a resource 16 or a requester 18 according to embodiments of the invention. The entity acting as the user device, SIP event server, resource or requester generally includes a processor 50 connected to a memory 52 and an interface 54. The memory typically includes instructions for the processor to perform steps associated with operating in accordance with embodiments of the present invention. As a resource, the memory may store a local database 56 containing resource information being requested by a requester 18. As an SIP event server, the memory may store a local database containing subscription information for devices or URIs. Also, as an SIP event server, the memory may store a cache 58 including authorizations from user devices for requesters and respective resources.

In accordance with embodiments of the present invention, the system 10 provides a session initiation protocol (SIP) framework. As such, the SIP event server 14 and the requester 18 are each registered with a corresponding local SIP proxy 22 and 24, respectively. Although not shown, it will be appreciated that one or more user devices 12 and/or resources 16 can also be registered with a corresponding local SIP proxy, and thus be part of the SIP framework. Also, although shown as separate logical entities, the SIP event server and/or SIP proxy 22 may be co-located. However, the SIP event server is generally an entity that is logically separate from a SIP proxy 22. Based on the system, then, methods of controlling access to one or more resources, and subsequent subscription and notification relating to the resources, according to embodiments of the present invention may be practiced.

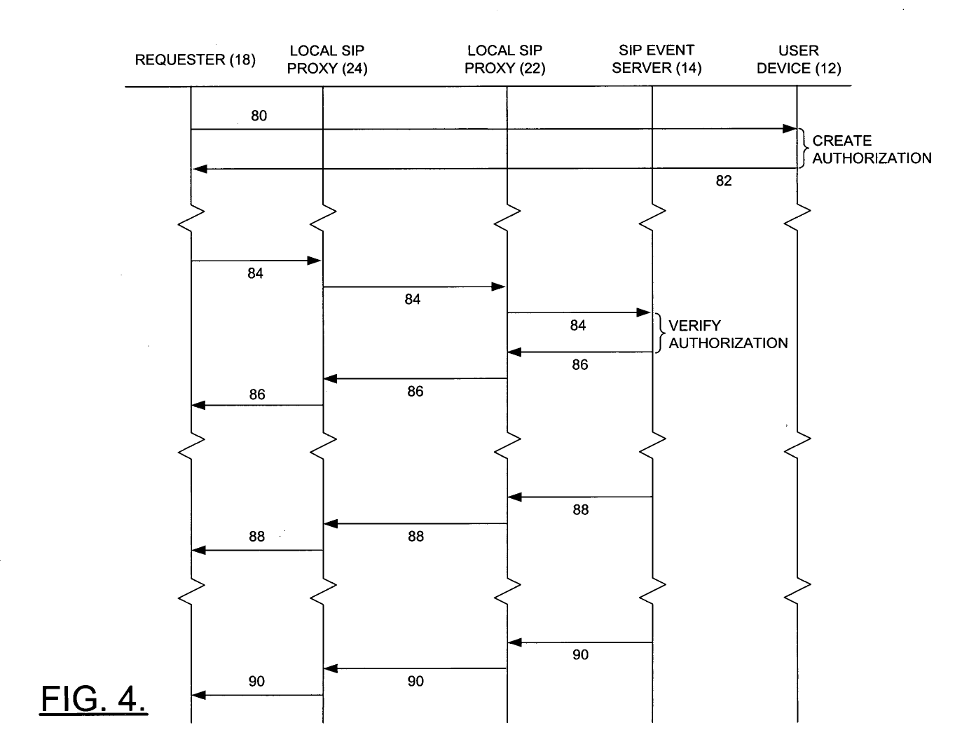

Reference is now made to FIG. 4, which illustrates a method of access control in accordance with one embodiment of the present invention, such as in the context of delivering location-based services. To receive access to an event according to embodiments of the present invention, a requester 18 must typically receive an authorization from the user to access the event-based information that is associated with the event and available from one or more of the resources 16 associated with the user device 12. In this regard, a method of access control includes the requester sending a request message 80 to the user device for access to event-based information available from a resource controlled by the user device.

The request for access can be sent to the user independent of an action of the user device, but in one advantageous embodiment, the request for access is sent to the user device in response to an action of the user device. For example, the user device can operate a Web browser to download a conventional Web page from a requester, such as by transmitting an HTTP GET request to the requester. The response from the requester can then contain a link, such as a hypertext link, to a resource-based (e.g., location-based) service. Advantageously, the response can also include a trigger associated with the link to the resource-based service that, when executed, activates a request for access to the event associated with the event-based information available from the resource. In this regard, the response from the requester may comprise a Web page including the hypertext link, which the user device may display. Thereafter, the user device can receive a selection of the resource-based service. Upon receiving the selection, the user device is triggered to launch and operate the software program to automatically generate an authorization for access to the requested resource (e.g., location information) of the user device so that the requester can deliver the resource-based service to the user device.

Whether or not the request for access is initiated by an action of the user device 12, the request may include any of a number of different pieces of information relating to the request to access the event-based information available from the resource. For example, the request may indicate the event-based information requested from the resource. Additionally, or alternatively, for example, the request may include parameters of the authorization, such as the granularity of the requested event-based information, the frequency with which the requester 18 may access the event-based information, and/or the time period (or expiration time) over which the requester may access the event-based information.

After the user device 12 receives the request, the user device, or more particularly the controller 50 when the user comprises a mobile station, operates a software program to create an authorization for the respective requester 18. During operation of the software program, then, the user may be prompted by the user device to grant consent for the requester to access the event-based information available from the resource. The user may also be prompted to enter or confirm parameters included in the authorization. For example, the user may be prompted to enter the granularity of the resource information, such as when the resource information comprises location information. In such an instance, the user may be prompted to enter the granularity in any of a number of different manners, such as in an intuitive manner by specifying logical attributes, such as street, zip code, city, country or the like. Alternatively, the user may be prompted to enter the granularity by specifying a region in some coordinate system.

As indicated, upon receiving the request for access to event-based information available from one or more resources 16 of the user device 12, the user device launches a software program to automatically generate an authorization for the requester 18 to access the resources. In one typical embodiment, the software program prompts the user for consent to provide the requester access to the requested event-based information. If the user does not consent to provide access to the event-based information, the requester cannot subsequently access the requested event-based information. If the user does grant consent to access the requested event-based information, however, the software application can interpret the parameters included in the request and display the parameters for the user to enter, confirm and/or modify. For example, upon granting consent for access to the requested event-based information, the software application may prompt the user to enter the desired granularity (e.g., current cell, exact coordinates, etc.) of the requested information (e.g., location information) provided to the requester, and prompt the user to confirm that the requester may access the requested information at a frequency of once per day for a time period of one week.

Upon granting consent and receiving, confirming and/or modifying the parameters of the authorization, the software application can automatically create the authorization. The authorization can be created in any number of manners, but typically comprises an electronic file that authorizes the requester 18 to access the requested event-based information available from the resource 16 of the user device 12 based upon the parameters included in the authorization. The authorization is typically either encrypted, includes a digital signature of the user device, or is password protected, such that the SIP event server 14 can subsequently verify the authenticity of the authorization, as described below. As will be appreciated, the digital signature, encryption or password protection of the authorization by the user device for interpretation by the SIP event server can be accomplished according to any of a number of known techniques.

After creating the authorization, the authorization is transmitted to the requester 18 along with the ID of the user device 12 as message 82. When the request is triggered by a request for a resource-based (e.g., location-based) service, a request for the resource-based service is transmitted to the requester along with the authorization and the ID of the user device, such as by utilizing an HTTP POST. After receiving the authorization, or the request for the resource-based service including the authorization, the requester 18 may subscribe to an event associated with the requested event-based information available from the resource 16 to thereby access the requested event-based information. In this regard, the requester may subscribe to notifications for authorized events. The requester can receive notifications related to authorized, subscribed-to events at periodic intervals, such as at predefined intervals or when the status changes for subscribed-to events, where the notifications are received in accordance with a respective authorization.

To subscribe to an event associated with event-based information for which the requester 18 has authorization, the requester can send a SUBSCRIBE message 84 to its corresponding local SIP proxy 24. The SUBSCRIBE message typically contains as a payload the description of the requested event-based information, as well as the event of interest, for example, registered/published or de-registered. According to embodiments of the present invention, the SUBSCRIBE message also contains the authorization received from the user device 12. The SUBSCRIBE message may further contain an “expires” parameter (not shown) indicating duration of the subscription. Depending on the length of the subscription, the requester 18 may receive periodic notifications in response to changes for the event or may receive a one-time notification.

The SUBSCRIBE message 84 according to this embodiment may be a message that is part of an extension to SIP as defined in IETF's request for comment document RFC 3265, entitled: SIP-Specific Event Notification, dated June 2002, the contents of which are hereby incorporated by reference in its entirety. The format of the service and/or information description in the payload may include, for example, attribute-based formats such as used in SLP, descriptions such as according to RDF-based formats, or a dedicated format for SIP service description. The SUBSCRIBE message is appropriately forwarded to the local SIP event server 14 via proxies 24 and 22. Upon reception of the SUBSCRIBE message, the local SIP event server 14 can parse the SUBSCRIBE message to extract the description of the requested event-based information, the user device ID and the authorization of the user device to access the requested event-based information. Once the SIP event server has extracted and/or received the description of the requested event-based information, the SIP event server can determine whether the SIP event server supports the resource 16 capable of providing the requested event-based information. If the SIP event server does not support the resource, the SIP event server does not accept the subscription and may additionally transmit a message, such as an error code message, to the requester informing the requester that the respective resource is not supported.

If the SIP event server 14 does support the resource capable of providing the requested event-based information, the SIP event server can decrypt, interpret the digital signature or provide a password to the authorization, and verify that the requester 18 is authorized to access the requested event-based information available from the resource 16. The SIP event server can verify the authorization in any number of different manners, including verifying that the authorization came from the respective user device 12 by decrypting, interpreting or providing a password associated with the authorization. Also, the SIP event server can verify the authorization by verifying that the parameters of the authorization have been met, such as by verifying that the frequency of accessing the event-based information, and/or the time period for accessing the event-based information, has not been exceeded.

As will be appreciated, then, the SIP event server 14 can verify the authorization by making use of a secret known only to the SIP event server and the user device 12. Such a secret (e.g., a cryptographic key, password, digital signature, etc.) is typically generated and securely transmitted to the SIP event server and the user device prior to the user device creating the authorization and the SIP event server verifying the authorization. For example, the secret can be transmitted to the SIP event server and the user device by an operator of the network 19 when the user subscribes to service with the operator. In such an instance, the secret can be managed (refreshed, modified, etc.) at regular intervals by the network operator, or in a peer-to-peer manner by the SIP event server and the user device.

If the authorization is not verified, the SIP event server 14 does not accept the subscription to thereby deny the requester 18 access to the event associated with the requested event-based information, and thus the requested event-based information. Additionally, the SIP event server may transmit a message, such as an error code message, to the requester informing the requester that the authorization was not verified. If the authorization is verified, however, the SIP event server accepts the subscription for the specified event, and stores the subscription in the local database 56 stored in memory 52 (shown in FIG. 3). The associated description and the expiration time for the subscription can also be stored in the local database. Further, the SIP event server can store the authorization in the cache 58 in memory, where the requester may be identified by its uniform resource identifier (URI) or other identifier. The SIP event server 14 can additionally confirm reception and verification of the subscription with a ‘200 OK’ message 86 sent to the requester 18 via proxies 22 and 24.

The SIP event server 14 can thereafter retrieve an indication as to whether the resource 16 is capable of providing the requested service and/or information. The SIP event server can determine the capability of the resource in any number of different manners. According to one embodiment, for example, the SIP event server may determine the capability of the resource, and/or retrieve the requested information, by polling the requested resource. As will be appreciated, the SIP event server can communicate with the resource in any of a number of different known manners, generally depending upon the type of resource. For example, presume the user device 12 comprises a mobile station such as that shown in FIG. 2 including a GPS sensor 41. In such an instance, the resource can comprise the GPS sensor, where a requester requests information comprising location information regarding the mobile station available from the GPS sensor. The SIP event server can then communicate with the GPS sensor to determine whether the GPS sensor can provide the location information, and/or to acquire the location information from the GPS sensor.

Upon reception of a response from the resource 16, the SIP event server can send a first NOTIFY message 88 back to the requester 18 via proxies 22 and 24. This message contains, for example, a description of the requested event-based information capable of being provided by the resource. Additionally, or alternatively, the NOTIFY message may contain the requested information in an appropriate format. If the resource is not presently capable of providing the requested event-based information, the payload may contain an appropriate indication. Upon reception of the NOTIFY message, the requester, or more particularly a respective application (not shown) on the requester, may extract, for example, the received information for further use, if available.

It will be appreciated that one embodiment of the present invention allows for a one-time discovery request/response scheme, which may be referred to as a QUERY. For a QUERY, the requester 18 sends a SUBSCRIBE message 84 for an event in which an expiration time of zero is specified for the subscription. In such an instance, the subscription is not stored in the local database 56 of the SIP event server 14. Thus, only the authorization verification and communication with the resource for available event-based information are performed, leading to an appropriate NOTIFY message 88 that is sent to the requester.

If the SUBSCRIBE in message 84 has not been a one-shot subscription, i.e., a non-zero expiration time has been given in message 84, the SIP event server 14 can perform appropriate functions upon reception of requested event-based information that has been added, deleted or otherwise modified. Hence, the SIP event server can periodically receive information regarding requested event-based information from the resource 16. The SIP event server can then compare the authorization with the added, deleted or otherwise modified event-based information. Thereafter, the SIP event server can generate appropriate NOTIFY messages 90 that are sent to the subscribed requester 18 in accordance with the authorization. These messages are appropriately routed through the SIP proxies 22, 24 to the requester, therefore notifying the requester of additions, deletions and/or modifications to the requested event-based information available from the resource.

As will be appreciated, by storing the authorization in the cache 58 in memory 52 of the SIP event server 14, the requester 18 need only send the authorization to the SIP event server once to access requested event-based information that satisfy the parameters of the authorization. As such, for each subsequent subscription from the requester to the SIP event server, as long as the authorization is valid for the subsequent subscription, the requester may send a SUBSCRIBE message to the SIP event server without the requisite authorization. Based upon the URI of the requester, as well as the user device ID and service and/or information description included in the SUBSCRIBE message, then, the SIP event server can search the cache for the respective authorization. If the cache includes such an authorization, and the authorization remains valid, the SIP event server can operate as described above beginning with sending an ‘200 OK’ message 86 to the requester 18 via proxies 22 and 24. Otherwise, the SIP event server will not accept the subscription unless the SUBSCRIBE message includes the requisite authorization.

It will be appreciated that the method of embodiments of the present invention is not exclusive of the methods by which an requester 18 can receive controlled access to resources 16 of the user device 12. For example, the system according to another embodiment of the present invention can include an access control list (ACL) as in one conventional technique for access control. In such an instance, the method of embodiments of the present invention can operate to provide access control according to the conventional technique when the requester is located in the ACL. Then, when the requester is not located in the ACL, the method can continue by creating and thereafter utilizing the authorization, such as in a manner described above.

The present invention is fully applicable to a wide range of services and content, as well as to other types of discoverable information, where it is desirable to control access to the services and content. As an example, suppose the SIP event server 14 serves a network for a business. Suppose that the business maintains many resources 16, such as computers, printers, telephones, facsimile machines and the like. In this regard, the resources may be included within a network including one or more user devices 12, such as networked computers, which control access to the respective resources. Under such a scenario, a user of a mobile station or other device (e.g., laptop computer) may act as a requester 18 and thereby request authorization to access, and thereafter access, the resources of the business.

Many modifications and other embodiments of the invention will come to mind to one skilled in the art to which this invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

1. A method for controlling access to an event maintained by an event server, the event associated with event-based information available within a network, the method comprising:
receiving, at a first network entity, consent to access the event-based information associated with the event, and automatically thereafter creating an authorization;
transmitting the authorization from the first network entity to a second network entity;
transmitting a subscription message from the second network entity to the event server, wherein the subscription message includes the authorization and an event package describing the event-based information; and
determining at the event server whether to accept the subscription message based upon the authorization.

2. A method according to claim 1 further comprising transmitting a request to access the event-based information associated with the event, wherein the request is transmitted from the second network entity to the first network entity prior to receiving consent to access the event-based information.

3. A method according to claim 2, wherein transmitting a request comprises:
transmitting a trigger from the second network entity to the first network entity; and
executing the trigger to thereby activate the request to access the event-based information.

4. A method according to claim 1, wherein the receiving a consent to access the event-based information associated with the event comprises receiving a consent to access the event-based information associated with the event with at least one parameter including at least one of a predefined granularity, frequency and time period, and wherein creating an authorization comprises creating an authorization including the at least one parameter.

5. A method according to claim 1, wherein determining whether to accept the subscription message comprises:
verifying the authorization; and
accepting the subscription message if the authorization is verified to thereby provide the second network entity with access to the event.

6. A method according to claim 5, wherein verifying the authorization includes verifying that at least one of a predefined frequency and time period has not been exceeded.

7. A method according to claim 5, wherein verifying the authorization includes verifying a shared secret.

8. A method according to claim 5, wherein accepting the subscription message comprises accepting the subscription message to thereby provide the second network entity with access to the event-based information with a predefined granularity.

9. A method according to claim 1 further comprising storing the authorization in a cache such that the event server can retrieve the authorization in response to receiving at least one subsequent subscription message, wherein the at least one subsequent subscription message includes an event package describing the event-based information.

10. A system for controlling access to an event maintained by an event server, the event associated with event-based information available within a network, the system comprising:
a first network entity capable of controlling access to the event-based information associated with the event, wherein the user device is capable of receiving consent to access the event-based information associated with the event, wherein the user device is capable of automatically creating an authorization upon receiving the consent, and thereafter transmitting the authorization;
a second network entity capable of receiving the authorization, and thereafter transmitting a subscription message, wherein the subscription message includes the authorization and an event package describing the event-based information; and
an event server capable of maintaining the event, wherein the event server is capable of receiving the subscription message, and thereafter determining whether to accept the subscription message based upon the authorization.

11. A system according to claim 10, wherein the second network entity is capable of transmitting a request to the first network entity to access the event-based information associated with the event, and wherein the request is transmitted prior to receiving consent to access the event-based information.

12. A system according to claim 11, wherein the second network entity is capable of transmitting the request by:
transmitting a trigger to the first network entity such that the first network entity can execute the trigger to thereby activate the request to access the event-based information.

13. A system according to claim 10, wherein the first network entity is capable of further receiving at least one parameter associated with the consent, wherein the at least one parameter includes a least one of a predefined granularity, frequency and time period, and wherein the first network entity is capable of creating the authorization including the at least one parameter.

14. A system according to claim 10, wherein the event server is capable of determining whether to accept the subscription message by:
verifying the authorization; and
accepting the subscription message if the authorization is verified to thereby provide the second network entity with access to the event.

15. A system according to claim 14, wherein the event server is capable of verifying the authorization by verifying that at least one of a predefined frequency and time period has not been exceeded.

16. A system according to claim 14, wherein the event server is capable of verifying the authorization by verifying a shared secret.

17. A system according to claim 14, wherein the event server is capable of accepting the subscription message to thereby provide the second network entity with access to the event-based information with a predefined granularity.

18. A system according to claim 10, wherein the event server maintains a cache, wherein the event server is capable of storing the authorization in the cache such that the event server can retrieve the authorization in response to receiving at least one subsequent subscription message, wherein the at least one subsequent subscription message includes an event package describing the event-based information.

19. A mobile station comprising:
a user interface capable of receiving consent to access event-based information associated with an event maintained by an event server, wherein the at least one of service and information are available within a network;
a controller capable of executing a software application to automatically create an authorization upon receipt of the consent; and
a transmitter capable of transmitting the authorization to a second network entity such that the second network entity can thereafter subscribe to the event based upon the authorization.

20. A mobile station according to claim 19, wherein the user interface is capable of receiving a request for access to thereby trigger the controller to execute the software application to present a prompt to receive consent to access the event-based information before the user interface receives the consent.

21. A mobile station according to claim 19, wherein the user interface is capable of further receiving at least one parameter associated with the consent, wherein the at least one parameter includes at least one of a predefined granularity, frequency and time period, and wherein the software application is capable of creating the authorization including at least one of the predefined granularity, frequency and time period.
